(19) United States
(12) Patent Application Publication
(10) Pub. No.: US 2026/0187375 A1
(43) Pub. Date: Jul. 2, 2026

(54) MULTI-LAYER ARTIFICIAL INTELLIGENCE FOR LANGUAGE MODEL CONTEXT SELECTION

(71) Applicant: AT&T Intellectual Property I, L.P., Atlanta, GA (US)

(72) Inventors: Mohammad Nikain, Atlanta, GA (US); Vahid Tavassoli, Alpharetta, GA (US); Daniel Connolly, Suwanee, GA (US)

(21) Appl. No.: 19/007,173

(22) Filed: Dec. 31, 2024

(51) Int. Cl. G06F 40/35; G06N 3/0455; G06N 3/0475

(52) U.S. Cl. CPC G06F 40/35; G06N 3/0455; G06N 3/0475

(57) ABSTRACT

A processing system may sectionalize a text file into overlapping sections, generate, for each section, a question from a text of the section, where the question is associated with the section in a question-section pair, and apply each question to a machine learning language model to generate answers to the questions. For each question, the applying may include appending the text of the section as supplemental prompt content. The processing system may associate each question with an answer to generate a respective question-answer pair and may group the question-answer pairs into groups based upon a similarity metric. The processing system may then identify, for at least a first group, a text sequence that is within an intersection of the sections in the question-section pairs of the first group, where the text sequence is associated with the first group as a result of the identifying.

The present disclosure relates generally to machine learning language models and telecommunication network operations, and more specifically to methods, computer-readable media, and apparatuses for processing a query via a machine learning language model using a text sequence identified within at least a portion of text file associated with a group that is matched to the query and that includes one or more questions of one or more question-answer pairs grouped based on a similarity metric.

### BACKGROUND

Generative artificial intelligence (AI) knowledge bases may contain significant amount of irrelevant information, which may contribute to unreliable answers being yielded for complex questions. The end result may be to live with the errors and hence only deploy generative AI in simpler cases, employ a lengthy and comprehensive process of reinforcement learning (RL) to reduce the errors, or provide questions (prompts) with long descriptions of expected characteristics of correct answers.

### SUMMARY

The present disclosure describes methods, computer-readable media, and apparatuses for processing a query via a machine learning language model using a text sequence identified within at least a portion of text file associated with a group that is matched to the query and that includes of one or more questions of one or more question-answer pairs grouped based on a similarity metric. For instance, in one example, a processing system including at least one processor may sectionalize at least a portion of a text file into a plurality of sections, wherein each section of the plurality of sections overlaps with at least one other section of the plurality of sections. Next the processing system may generate, for each section of the plurality of sections, a question from a respective text of the section, where the question is associated with the section in a question-section pair, and where the generating results in a plurality of question-section pairs associated with a plurality of questions for the plurality of sections. In addition, the processing system may apply each question of the plurality of questions to a machine learning language model that is configured to generate a plurality of answers to the plurality of questions, where for each question, the applying includes appending the respective text of the section that is associated with the question as supplemental prompt content. The processing system may further associate each question with a respective answer of the plurality of answers obtained via the applying to generate a question-answer pair of a plurality of question-answer pairs and may group the plurality of question-answer pairs into a plurality of groups based upon a similarity metric. The processing system may then identify, for at least a first group of the plurality of groups, a text sequence that is within an intersection of the sections in the question-section pairs associated with the respective questions in the question-answer pairs within the first group, where the text sequence is associated with the first group as a result of the identifying. In one example, the processing system may further obtain a query for the machine learning language model, matching the query to the first group, and process the query via the machine learning language model to obtain a first answer to the query as an output, where the query is processed via the machine learning model using with the text sequence as additional context based upon the matching.

### BRIEF DESCRIPTION OF THE DRAWINGS

The present disclosure can be readily understood by considering the following detailed description in conjunction with the accompanying drawings, in which:

FIG. 1 illustrates an example of a system related to the present disclosure;

FIG. 2 illustrates an example process for indexing a text file for focused context retrieval for a machine learning language model, in accordance with the present disclosure;

FIG. 3 illustrates an example of sectorizing/chunking a portion of a text file into overlapping sections, in accordance with the present disclosure;

FIG. 4 illustrates a flowchart of an example method for processing a query via a machine learning language model using a text sequence identified within at least a portion of text file associated with a group that is matched to the query and that includes one or more questions of one or more question-answer pairs grouped based on a similarity metric; and

FIG. 5 illustrates a high-level block diagram of a computing device specially programmed to perform the functions described herein.

To facilitate understanding, identical reference numerals have been used, where possible, to designate identical elements that are common to the figures.

### DETAILED DESCRIPTION

The present disclosure broadly discloses methods, non-transitory (i.e., tangible or physical) computer-readable media, and apparatuses for processing a query via a machine learning language model using a text sequence identified within at least a portion of text file associated with a group that is matched to the query and that includes one or more questions of one or more question-answer pairs grouped based on a similarity metric. In particular, examples of the present disclosure provide for a more accurate and focused context retrieval to enable a generative artificial intelligence (AI) system, e.g., a machine learning (ML) language model-based system, to provide more accurate answers and hence reduce “hallucinations” and “bias.” This is accomplished without requiring significantly larger compute resources or expensive reinforcement through human feedback (RLHF).

Notably, one issue with generative AI is the fact that the “knowledge bases” (e.g., the collection of documents and/or other information that is fed into the system) may contain significant amount of irrelevant information, which may contribute to unreliable answers being yielded for complex questions. The end result may be one of the three: (1) live with the errors and hence only deploy generative AI in simpler cases (current solutions), (2) employ a lengthy and comprehensive process of reinforcement learning (RL) to reduce the errors (computationally and monetarily expensive), or (3) provide questions (prompts) with long descriptions of what the answers should be (also expensive and less effective unless combined with reinforcement learning, since the cost of AI services/operations may increase exponentially with increases in length of prompts). In contrast, examples of the present disclosure identify a more narrowly focused context, so that only the most relevant data can be fed to the backend generative AI (e.g., a ML language model), which may reduce the hallucinations and bias without the need for RLHF or expansive prompts (e.g., items 2 and 3 above). In one example, the present disclosure may include a multi-phase/multi-step process which may be handled in a completely automated system.

To illustrate, in one example, a first phase may include a first AI agent that breaks a document into a set of overlapping sections (e.g., paragraphs or sub-paragraphs of varying lengths, or the like). This may comprise a streamlined AI algorithm and/or machine learning model (MLM) that is focused on recognizing document structure: e.g., paragraphs, sentences, breaks, tables, charts, etc. It should be noted that as referred to herein, “AI agents” may refer to AI processes or systems, including a machine learning (ML)-based processes/systems, that are fine-tuned for specific purposes. In a second phase, a second AI agent may be tasked with automatic generation of “questions” based on the text content of each section. In a third phase, a language model, e.g., core ML language model (such as a large language model (LLM)) may be prompted to answer the questions produced in the second phase. In one example, the prompting for each question may include limiting the passing of additional context to include only the content of the section from which the respective question was produced. As a result of phase three, the present disclosure may have an associated question, answer, and section of a document. It should be noted that the second and third phases may be repeated for each section produced in the first phase to obtain at least one question and answer pair for each section.

Notably, the sections may be picked in the first phase without regard to context (e.g., instead of being selected with respect to punctuation, indentation, line breaks, etc.). Thus, each section may include additional information irrelevant to the questions produced in the second stage. Accordingly, in one example, a fifth phase may include a third AI agent performing a similarity analysis between questions and answers pairs. In particular, a question-answer pair that is similar to another-question answer pair may have a similar origin in the source document. These question-answer pairs may be placed into a same group (and likewise for other similar question-answer pairs to produce a plurality of similarity sets/groups). For a given group, there may be a set of sections that produce similar questions and answers. In this regard, at a sixth phase, the system may extract the common/shared parts, e.g., for each group, find a text sequence that is within each/all of the sections for questions/question-answer pairs of the group. This text sequence that is at the intersection of the sections associated with the group may be considered to be the core piece of information that contains an answer to a question in the group (e.g., where the questions are all “similar” according to the similarly metric of the question-answer pairs.).

Further refinement may be obtained by repeating these phases. Since it does not require any human involvement, it can be done relatively inexpensively and at high speed. The foregoing may thus develop a data set that may be used to enhance live question processing by a generative AI/ML language model-based system. In particular, a query (e.g., a question) may be placed to the generative AI/ML language model-based system. The query may be mapped to a group of similar questions, e.g., as produced in the fifth phase. Accordingly, the generative AI/ML language model-based system may retrieve the associated text sequence, e.g., the core piece of information relevant to the questions in the group and hence relevant to the new/live query that is similar thereto. In addition, the text sequence may be applied as additional context, e.g., for a core ML language model to process the query and to produce an output comprising an answer thereto.

For instance, in one example, the present disclosure may include a retrieval augmented generation (RAG) process to extract relevant additional context as supplemental prompt content for the core ML language model. Alternatively, or in addition, the core ML language model may be fine-tuned, e.g., in a reinforcement learning through AI feedback (RLAF) process. For example, the foregoing produces a known correct context for a given question (or set of similar questions in a group). Thus, RLAF may be implemented by feeding known questions/queries to the core ML language model and then tracking whether, how often, and/or with what percentage of accuracy the core ML language model produces known correct answers. As such, reinforcement learning may be used to promote correct behaviors and hence fine-tune the core ML language model to pick the most concise context for each question. Alternatively, or in addition, RLAF may be deployed with respect to a context retrieval sub-component of the core ML language model. For instance, the core ML language model may include sub-components that are semi-independently trainable/configurable, e.g., in accordance with different objective functions. Accordingly, RLAF may include verifying the correctness of contexts retrieved based on feeding known questions in the various groups to the context retrieval sub-component and verifying the correctness of the contexts retrieved (e.g., text sequences extracted from a source document).

To further illustrate, examples of the present disclosure may provide a language model agent or language model-based agent. In one example, the present disclosure may fine tune a machine learning model (MLM), such as a large language model (LLM) (e.g., a generative pre-trained transformer (GPT) model, or the like), to provide high-level instructions to address communication network-specific issues. For instance, such an LLM may be used as a core LLM for a LLM-based agent (also referred to herein as a LLM agent or language model agent) of the present disclosure. In addition, in one example, the present disclosure may further enhance such a fine-tuned LLM to provide concrete actionable instructions, e.g., using specific agent tools. For instance, a LLM agent of the present disclosure may further include a retrieval augmented generation (RAG) process loop to index network equipment and/or network function vendor documentation, network operator internal documents, cellular technology technical standards, such as 3rd Generation Partnership Project (3GPP) technical standards (TS), or the like in a vector store. In one example, the present disclosure may further provide a web-based interface, e.g., a graphical user interface (GUI), for network personnel to interact with the LLM agent to submit requests, to obtain outputs, to provide user feedback to continuously improve RAG and other functionalities of the LLM agent, and so forth. In addition, in various examples, the present disclosure may be implemented using the current and/or future tools and technologies, such as using a LangChain framework with Snowflake application programming interface (API), large language model(s) (LLM(s) (such as OpenAI and others), Streamlit user interface (UI) implementation, and so forth.

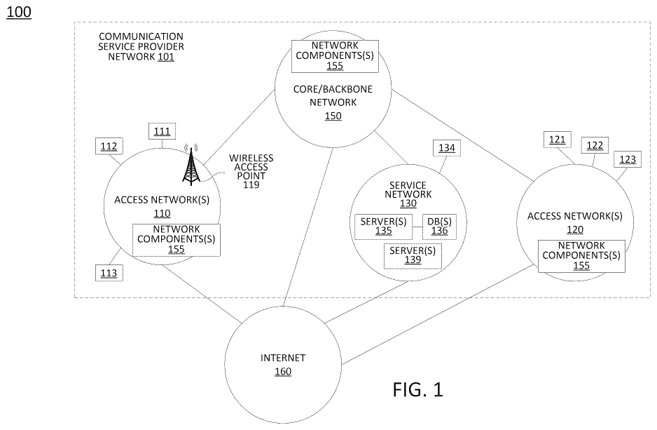

Thus, examples of the present disclosure may yield a generative AI/ML language model-based system that is trained to pick the best and most concise context without human involvement, and with superior performance and reduced costs (e.g., as compared to alternative solutions such as mentioned above). In this regard, examples of the present disclosure may enable the use of generative AI, e.g., ML language model-based systems, in more time critical and sensitive applications (e.g., where limited data access is desirable), yielding further cost reduction, benefits, and overall reliability. These and other aspects of the present disclosure are discussed in greater detail below in connection with the examples of FIGS. 1-5.

To aid in understanding the present disclosure, FIG. 1 illustrates an example system 100 comprising a plurality of different networks in which examples of the present disclosure may operate. Communication service provider network 101 may comprise a core network and/or backbone network 150 with components for telephone services, Internet services, and/or video services (e.g., triple-play services, etc.) that are provided to customers (broadly “subscribers”), and to peer networks. In one example, core/backbone network 150 may combine core network components of a cellular network with components of a triple-play service network. For example, communication service provider network 101 may functionally comprise a fixed-mobile convergence (FMC) network, e.g., an IP Multimedia Subsystem (IMS) network. In addition, core/backbone network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Communication service provider network 101 may also further comprise a broadcast video network, e.g., a cable television provider network or an Internet Protocol Television (IPTV) network, as well as an Internet Service Provider (ISP) network. With respect to video/television service provider functions, core/backbone network 150 may include one or more video servers for the delivery of video content, e.g., a broadcast server, a cable head-end, a video-on-demand (VoD) server, and so forth. For example, core/backbone network 150 may comprise a video super hub office, a video hub office and/or a service office/central office.

In one example, access/service networks 110 and 120 may provide one or more services to subscribers and/or customer premises, such as voice, data, video, and/or wireless access services, virtual local area network (VLAN) services, and so forth. For instance, access/service networks 110 and 120 may each comprise a Digital Subscriber Line (DSL) network, a broadband cable access network, a Local Area Network (LAN), a cellular or non-cellular wireless access network, and the like. For example, access/service networks 110 and 120 may transmit and receive communications between endpoint devices 111-113, endpoint devices 121-123, and data center network 130 (broadly a service network), and between core/backbone network 150 and endpoint devices 111-113 and 121-123 relating to voice telephone calls, communications with web servers via the Internet 160, and so forth. Access/service networks 110 and 120 may also transmit and receive communications between endpoint devices 111-113, 121-123 and other networks and devices via Internet 160. In another example, one or both of the access/service networks 110 and 120 may comprise an ISP network external to communication service provider network 101, such that endpoint devices 111-113 and/or 121-123 may communicate over the Internet 160, without involvement of the communication service provider network 101. Endpoint devices 111-113 and 121-123 may each comprise customer premises equipment (CPE), user equipment (UE), and/or other endpoint device types, such as a telephone, e.g., for analog or digital telephony, a mobile device, such as a cellular smart phone, a laptop, a tablet computer, etc., a router (e.g., a customer edge (CE) router), a gateway, a desktop computer, a plurality or cluster of such devices, a television (TV), e.g., a “smart” TV, or a set-top box (STB).

In one example, the access/service networks 110 and 120 may be different types of access networks. In another example, the access/service networks 110 and 120 may be the same type of access network. In one example, one or more of the access/service networks 110 and 120 may be operated by the same or a different service provider from a service provider operating the communication service provider network 101. For example, each of the access/service networks 110 and 120 may comprise an Internet service provider (ISP) network, a cable access network, and so forth. In another example, each of the access/service networks 110 and 120 may comprise a cellular access network, implementing such technologies as: global system for mobile communication (GSM), e.g., a base station subsystem (BSS), GSM enhanced data rates for global evolution (EDGE) radio access network (GERAN), or a UMTS terrestrial radio access network (UTRAN) network, among others, where core/backbone network 150 may provide cellular core network functions, e.g., of a public land mobile network (PLMN)-universal mobile telecommunications system (UMTS)/General Packet Radio Service (GPRS) core network, or the like. For instance, access/service network(s) 110 may include at least one wireless access point (AP) 119, e.g., a cellular base station, such as an eNodeB, or gNB, a non-cellular wireless access point (AP), such as an Institute of Electrical and Electronics Engineers (IEEE) 802.11 (Wi-Fi) access point, or the like. In still another example, access/service networks 110 and 120 may each comprise a home network or enterprise network, which may include a gateway to receive data associated with different types of media, e.g., television, phone, and Internet, and to separate these communications for the appropriate devices. For example, data communications, e.g., Internet Protocol (IP) based communications may be sent to and received from a router in one of the access/service networks 110 or 120, which receives data from and sends data to the endpoint devices 111-113 and 121-123, respectively.

In this regard, it should be noted that in some examples, endpoint devices 111-113 and 121-123 may connect to access/service networks 110 and 120 via one or more intermediate devices, such as a home or enterprise gateway and/or router, e.g., where access/service networks 110 and 120 comprise cellular access networks, ISPs and the like, while in another example, endpoint devices 111-113 and 121-123 may connect directly to access/service networks 110 and 120, e.g., where access/service networks 110 and 120 may comprise local area networks (LANs), enterprise networks, and/or home networks, and the like.

In one example, communication service provider network 101 may also include one or more network components 155 (e.g., in core/backbone network 150 and/or access/service networks 110 and 120). Network components 155 may include various physical components of communication service provider network 101. For instance, network components 155 may include various types of optical network equipment, such as an optical network terminal (ONT), an optical network unit (ONU), an optical line amplifier (OLA), a fiber distribution panel, a fiber cross connect panel, and so forth. Similarly, network components 155 may include various types of cellular network equipment, such as a mobility management entity (MME), a mobile switching center (MSC), an eNodeB, a gNB, a base station controller (BSC), a baseband unit (BBU), a remote radio head (RRH), an antenna system controller, and so forth. In one example, network components 155 may alternatively or additionally include voice communication components, such as a call server, an echo cancellation system, voicemail equipment, a private branch exchange (PBX), etc., short message service (SMS)/text message infrastructure, such as an SMS gateway, a short message service center (SMSC), or the like, video distribution infrastructure, such as a media server (MS), a video on demand (VoD) server, a content distribution node (CDN), and so forth. Network components 155 may further include various other types of communication network equipment such as a layer 3 router, e.g., a provider edge (PE) router, an integrated services router, etc., an Internet exchange point (IXP) switch, and so on. In one example, network components 155 may further include virtual components, such as a virtual machine (VM), a virtual container, etc., software defined network (SDN) nodes, such as a virtual mobility management entity (vMME), a virtual serving gateway (vSGW), a virtual network address translation (NAT) server, a virtual firewall server, or the like, and so forth. In addition, in one example, network component 155 may include measurement systems, such as network probe devices or the like, to test connectivity across core/backbone network 150, access/service network(s) 110, and/or access/service network(s) 120 (e.g., end-to-end and/or within a selected network segment, etc.). In addition, for ease of illustration, various components of communication service provider network 101 are omitted from FIG. 1.

Still other network components 155 may include a database of assigned telephone numbers, a database of basic customer account information for all or a portion of the customers/subscribers of the communication service provider network 150, a cellular network service home location register (HLR), e.g., with current serving base station information of various subscribers, and so forth, a Simple Network Management Protocol (SNMP) trap, or the like, a billing system, a customer relationship management (CRM) system, a trouble ticket system, an inventory system (IS), an ordering system, an enterprise reporting system (ERS), an account object (AO) database system, and so forth. In addition, other network components 155 may include, for example, a layer 3 router, a short message service (SMS) server, a voicemail server, a video-on-demand server, a server for network traffic analysis, a database server/database system, and so forth. It should be noted that in one example, a communication network component may be hosted on a single server, while in another example, a communication network component may be hosted on multiple servers, e.g., in a distributed manner.

In accordance with the present disclosure, network components 155 may comprise “network resources” of various network resource types, which may also include services provided and/or hosted via network components 155, e.g., enterprise communication services, such as a virtual private network (VPN) service, a virtual local area network (VLAN) service, a Voice over Internet Protocol (VoIP), a software defined-wide area network (SD-WAN) service, an Ethernet wide area network E-WAN service, and so forth. Alternatively, or in addition, network resources may include interfaces or ports associated with such services, such as a customer edge (CE) router or PBX-to-time division multiplexing (TDM) gateway interface, a Border Gateway Protocol (BGP) interface (e.g., between BGP peers), and so forth. For instance, a CE router, PBX, or the like may be homed to one or several provider edge (PE) routers or other edge component(s).

In one example, the data center network 130 may comprise a local area network (LAN), or a distributed network connected through permanent virtual circuits (PVCs), virtual private networks (VPNs), and the like for providing data and voice communications. In one example, the data center network 130 may comprise one or more devices for providing services to subscribers, customers, and/or users. For example, communication service provider network 101 may provide a cloud storage service, web server hosting, and other services. As such, data center network 130 may represent aspects of communication service provider network 101 where infrastructure for supporting such services may be deployed. In one example, the data center network 130 may alternatively or additionally comprise one or more devices supporting operations and management of communication service provider network 101. For instance, in the example of FIG. 1, server(s) 139 may include higher level services/applications such as a database of assigned telephone numbers, a database of basic customer account information for all or a portion of the customers/subscribers of the communication service provider network 101, a billing system, a customer relationship management (CRM) system, a trouble ticket system, an ordering system, an enterprise reporting system (ERS), an account object (AO) database system, a network inventory system, a network topology/mapping system, a network provisioning system, a unified data repository (UDR), and so forth. In one example, server(s) 139 may alternatively or additionally comprise one or more of the types of network components 155 described above.

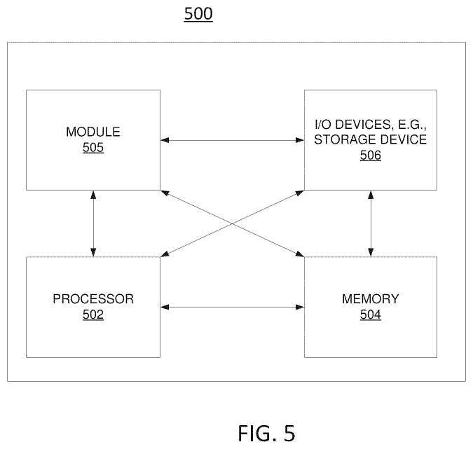

In addition, data center network 130 may include one or more servers 135 which may each comprise all or a portion of a computing device or system, such as computing system 500, and/or processing system 502 as described in connection with FIG. 5 below, specifically configured to perform various steps, functions, and/or operations for processing a query via a machine learning language model using a text sequence identified within at least a portion of text file associated with a group that is matched to the query and that includes one or more questions of one or more question-answer pairs grouped based on a similarity metric, as described herein. For example, one of the server(s) 135, or a plurality of the servers 135 collectively, may perform operations in connection with the example method 400, or as otherwise described herein.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below) or multiple computing devices collectively configured to perform various steps, functions, and/or operations in accordance with the present disclosure.

In one example, data center network 130 may also include one or more databases (DBs) 136, e.g., physical storage devices integrated with server(s) 135 (e.g., database servers), attached or coupled to the server(s) 135, and/or in remote communication with server(s) 135 to store various types of information in connection with examples of the present disclosure. For example, DB(s) 136 may be configured to receive and store network topology data, including the type(s) of network resources/network elements (e.g., both physical and virtual), the locations of such network resources, the connectivity between resources, the allocation of such resources to sub-nets, tracking areas, or the like, and so forth. In one example, the network topology information/data may include or may be cross-referenced to network inventory data, such as, for physical network resources, the manufacture date, the purchase date, the deployment date, the last serviced date and/or a service history, identities of the service technician(s), an incident/event list (e.g., for past network events associated with the network resource), a serial number, a model number, a version number, a software version, and so forth. In one example, the network topology data may comprise a network graph, or network graph database. For instance, nodes in the graph/graph database may represent network resources, network zones, etc., where some links/edges may represent physical links, or logical paths over physical links, while other links/edges may represent logical relationships, such as a virtual network function (VNF) being instantiated on a particular network function virtualization infrastructure (NFVI) physical element, a network resource being a component of a particular sub-net or tracking area, etc.

In addition, DB(s) 136 may be configured to receive and store network operational data, including performance indicator data (e.g., “key performance indicators” (KPIs)), such as: utilization and/or availability levels of network resources, configuration settings and/or parameters of such network resources, alarm data, and so forth. For instance, such data may be collected from various network components 155 reporting to server(s) 135 and/or to DB(s) 136, such as routers, RAN elements, cellular core network components, video distribution components, storage servers, content distribution network nodes, etc. It should be noted that some or all of such information (network topology and/or network operational data) may be contained in other network databases/systems, such as one or more of an active and available inventory (A&AI) database, a network inventory database, a call detail records (CDR) repository, or the like (e.g., represented by server(s) 139 and/or various network components 155).

Alternatively, or in addition, DB(s) 136 may be configured to receive and store customer/subscriber network resource order information (e.g., an additional type or types of network operational data), such as the subscriber/customer identities and other characteristics (e.g., a customer intensity value and/or a customer segment as described herein), the timing of such orders, the quantities of such orders, the type of service(s) ordered, and so forth. Similar to the above, some or all of such information may be contained in other network databases/systems, such as one or more of an authentication, authorization, and accounting (AAA) server/system, an operations support system (OSS), a business support system (BSS), a unified data repository (UDR), or the like. It should be noted that in accordance with the present disclosure, the network topology information/data and/or network operational data stored in DB(s) 136 or elsewhere may be maintained over a period of time. For instance, DB(s) 136 may store respective time series data indicative of different states of a network topology, different utilization and/or assignment levels of various network resources of various types in a given time interval (and over a period of a plurality of time intervals), etc. In one example, data may be segregated by customer segment, network zone, geographic region, and so forth.

In one example, DB(s) 136 may alternatively or additionally comprise a communication network technology documentation repository. For instance, this may include subscriber service documentation, cellular technology standards documentation (e.g., network standards documentation, such as 3GPP technical standards documentation, Internet Engineering Task Force (IETF) standards documents (e.g., RFCs that have status of Internet Standard or Best Current Practice (BCP), or the like), International Telecommunication Union Telecommunication Standardization Sector (ITU-T) recommendations, standards and/or specifications, e.g., Data Over Cable Service Interface Specification (DOCSIS), etc., IEEE standards (e.g., 802.11/Wi-Fi standards, etc., or the like), network operator documentation (e.g., procedures, manuals, best practices, whitepapers, etc.), at least one cellular network-related law or regulation, or the like. For example, the set of available laws and regulations can be previously specified by a system operator in advance. In other words, the documentation repository may not include the entirety of US federal and state statutes, Code of Federal Regulations, and state and local regulations, etc. Rather, the set of laws and regulations may be initially bounded by placing those that are deemed relevant to cellular network technologies in a database of selected laws and regulations. In one example, the network technology documentation in the network technology documentation repository may include computer programming code for configuring various network functions, or the like.

In one example, DB(s) 136 may also store artificial intelligence (AI) models and/or machine learning models (MLMs) that may be trained by, activated, and/or deployed by server(s) 135 in connection with examples of the present disclosure. In one example, server(s) 135 and/or DB(s) 136 may comprise cloud-based and/or distributed data storage and/or processing systems comprising one or more servers at a same location or at different locations. For instance, DB(s) 136, or DB(s) 136 in conjunction with one or more of the servers 135, may represent a distributed file system, e.g., a Hadoop® Distributed File System (HDFS™), or the like. In one example, the one or more of the servers 135 and/or server(s) 135 in conjunction with DB(s) 136 may comprise a generative MLM-based communication network knowledge platform (e.g., a network-based and/or cloud-based service hosted on the hardware of server(s) 135 and/or DB(s) 136).

It should be noted that as referred to herein, a machine learning model (MLM) (or machine learning-based model) may comprise a machine learning algorithm (MLA) that has been “trained” or configured in accordance with input training data to perform a particular service. For instance, an MLM may comprise a deep learning neural network, or deep neural network (DNN), a convolutional neural network (CNN), a recurrent neural network (RNN), a long short-term memory (LSTM) model, a generative adversarial network (GAN), a decision tree algorithm/model, such as gradient boosted decision tree (GBDT) (e.g., XGBoost, XGBR, or the like). In one example, one or more MLMs of the present disclosure may include supervised learning and/or reinforcement learning (e.g., using positive and negative examples after deployment as a MLM), and so forth. In one example, MLAs/MLMs of the present disclosure may be in accordance with an open source library, such as OpenCV, which may be further enhanced with domain-specific training data. In one example, MLMs of the present disclosure may include an ML-based generative model (e.g., a type of generative AI model/system), such as a language model, e.g., a “large language model” (LLM). For instance, an ML-based generative model used in the present examples, e.g., a ML language model, may comprise a generative adversarial network (GAN), a bidirectional encoder representations from transformers (BERT) model (e.g., BERT-Base, BERT-Large, etc.), a generative pre-training (GPT) model (e.g. GPT, GPT-2, GPT-3, or the like), a pathways language model (PaLM) a Language Model for Dialogue Applications (LaMDA) model, or other generative natural language processing (NLP) models. In one example, language models of the present disclosure may comprise an ada text embedding model.

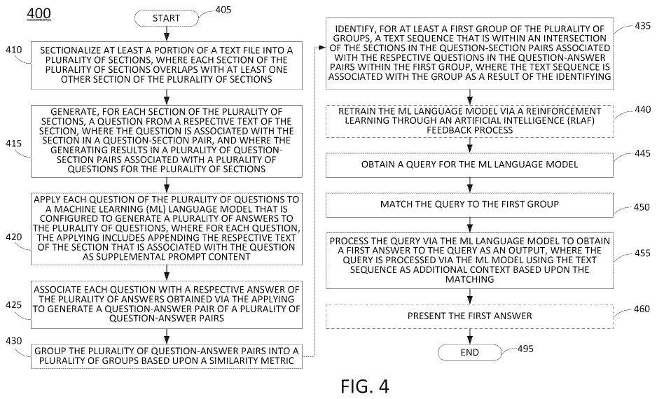

As noted above, server(s) 135 may be configured to perform various steps, functions, and/or operations for processing a query via a machine learning language model using a text sequence identified within at least a portion of text file associated with a group that is matched to the query and that includes of one or more questions of one or more question-answer pairs grouped based on a similarity metric, such as illustrated in FIG. 4 and described in greater detail below in connection with the example method 400. For example, server(s) 135 may comprise a generative MLM-based communication network knowledge platform that may be used by network personnel for network operations and management, network troubleshooting and maintenance, network planning, personnel training/learning, and other network management tasks.

In accordance with the present disclosure, server(s) 135 may comprise a language model agent or language model-based agent, e.g., a LLM agent. In one example, the language model agent, e.g., server(s) 135, may comprise a language model core, also referred to herein as a machine learning (ML) language model, e.g., comprising a LLM or the like. Server(s) 135 may further include a plurality of agent tools, or agent tool interfaces (e.g., application programming interfaces (APIs), webhooks, or the like) to call/interact with various tools, also referred to herein as AI agents. For example, AI agents may include a text file sectionalizer agent/tool, a question generator tool, a question-answer grouping tool, and so forth. Other tools may include a retrieval augmented generation (RAG)/vector database search/context retrieval tool, and so forth.

To further illustrate, server(s) 135 may sectionalize at least a portion of a text file (e.g., contained in the network technology documentation repository of DB(s) 136) into a plurality of sections, where each section of the plurality of sections overlaps with at least one other section of the plurality of sections. Server(s) 135 may then generate, for each section of the plurality of sections, a question from a respective text of the section. For instance, server(s) 135 may accomplish this task via a first AI agent, or agent tool. In one example, the question for each section may be associated with the respective section in a question-section pair. In this regard, the generating may result in a plurality of question-section pairs. In one example, multiple questions may be formulated for each section at this phase. Thus, each section may be the source of more than one question-section pair.

Server(s) 135 may then apply each question of the plurality of questions to a ML language model (e.g., a ML-based language model core, such as a LLM) that is configured to generate a plurality of answers to the plurality of questions. For instance, for each question, the applying may include appending the respective text of the section that is associated with the question as supplemental prompt content (e.g., retrieval augmented generation (RAG) content). In addition, server(s) 135 may associate each question with a respective answer of the plurality of answers obtained via the applying to generate a question-answer pair of a plurality of question-answer pairs. Next, server(s) 135 may group the plurality of question-answer pairs into a plurality of groups based upon a similarity metric. Finally, server(s) 135 may identify, for at least a first group of the plurality of groups, a text sequence that is within an intersection of the sections in the question-section pairs associated with the respective questions in the question-answer pairs within the first group. As a result, the text sequence may be associated with the group as a result of the identifying.

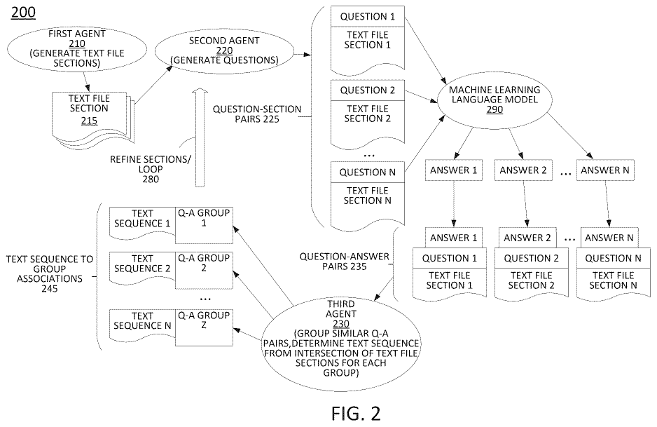

In one example, the text sequence may be stored in association with the questions in the group (or a question that is representative of the group, or a vector in a vector/feature space that is collectively representative of the questions in the group). For instance, server(s) 135 may store these associations in a data set in DB(s) 136, which may be used in connection with live questions/queries for the generative MLM-based communication network knowledge platform, e.g., to be processed via the ML language model core of the language model agent of server(s) 135. For instance, server(s) 135 may obtain a query for the ML language model, and may match the query to the first group (e.g., to one or more queries in the group, such as a representative query of the group and/or to a vector representation of the group collectively/as a whole). Server(s) 135 may then process the query via the ML language model to obtain a first answer to the query as an output, where the query is processed via the ML model using with the text sequence as additional context based upon the matching. For instance, this may comprise including the context as RAG content/supplemental prompt content, or may include further fine-tuning of the ML language model using questions with known text sequences as “correct” contexts to be retrieved and/or the answers as “correct” answers to the questions and then tracking the ML language model performance (e.g., the accuracy of outputs/answers). FIG. 2 illustrates additional aspects of the foregoing functionality of server(s) 135 in an example process flow 200. In addition, it should be noted that servers(s) 135 may alternatively or additionally perform various operations as described in connection with FIGS. 2-4, or elsewhere herein.

In addition, it should be realized that the system 100 may be implemented in a different form than that illustrated in FIG. 1, or may be expanded by including additional endpoint devices, access networks, network elements, application servers, etc. without altering the scope of the present disclosure. As just one example, any one or more of the server(s) 135 and DB(s) 136 may be distributed at different locations, such as in or connected to access/service networks 110 and 120, in another service network connected to Internet 160 (e.g., a cloud computing provider), in core/backbone network 150, and so forth. In addition, although the foregoing is described with respect to documentation of a communication network technology documentation repository, it should be noted that other, further, and different examples may involve synthetic documentation/text files. For instance, tabular data may be converted into readable text form using a conversion AI agent/tool. Alternatively or in addition, network topology/network graph data may be similarly converted into readable text format prior to processing via a first stage in accordance with the present disclosure (e.g., prior to text file sectionalization).

In still other examples, the present disclosure may further extend to domains beyond communication network management. For instance, this may include preparing text files for faster context retrieval relating to: automotive, aircraft, or watercraft maintenance, relating to history or arts sub-genres and/or specific books, stories, poems, anthologies, etc., relating to the sciences, construction, medical arts, and so forth. For instance, in each case, the present disclosure may include a ML language model core, e.g., which may be fine-tuned/pre-tuned with respect to the particular domain, and where additional documentation may be ingested and indexed in accordance with the present disclosure for faster and more accurate (e.g., more focused) context retrieval in connection with processing of live questions/queries. In this regard, DB(s) 136 may store any or all of such types of documentation, e.g., where server(s) 135 may provide a generative MLM-based knowledge platform as a service to users/entities external to the network operator itself. Thus, these and other modifications are all contemplated within the scope of the present disclosure.

FIG. 2 illustrates an example process 200 for indexing a text file (or at least a portion thereof) for focused context retrieval for a ML language model in accordance with the present disclosure. In particular, the process 200 may begin with a first agent 210 (e.g., a first agent tool or AI agent) taking a text file, or at least a portion thereof, and generating a plurality of text file sections 215. For instance, the first agent 210 may sectionalize text file contents into text file sections 215 based upon one or more of: line break markers, paragraph break markers, section break markers, indentation markers, punctuation markers, or grammatical markers. However, it should be noted that the purpose of the first agent 210 is to generate overlapping text file sections 215 rather than sections with clean breaks. Thus, the first agent 210 does not parse the text file for contents and semantic concepts to determine the section boundaries. In one example, the first agent 210 may comprise a chunking algorithm. For instance, the first agent 210 may implement a fixed-size chunking, a random-size chunking, a format-aware chunking (e.g., to respect structured text indicators such as headers, form fields, etc.), and so on. In one example, the first agent 210 may comprise a first machine learning model (MLM) such as a CNN, e.g., a DNN, etc. In one example, the first agent 210 may be format-aware with respect to a physical layout on a page. For example, the text file may not be a raw text, but may include an article with inset boxes, diagram captions, footnotes, etc. As such, the sectionalization/chunking of the text file may be informed by visual/layout features in addition to aspects of the text itself. In one example, different segmenting/chunking techniques may be used to obtain different section boundaries (since the goal is to produce partially overlapping text file sections 215). It should also be noted that as referred to herein, a text file may comprise a document in any source format (e.g., a Microsoft Word™ document, a Portable Document Format (PDF) document, an American Standard Code for Information Interchange (ASCII) text format, a LaTeX formatted document, etc. In addition, a text file may also refer to programming code, libraries, etc. according to various programming languages, markup languages, or the like.

As noted above, a second agent 220 may next take the text file sections 215 and may generate one or more questions from each respective one of the text file sections 215. In one example, the second agent may comprise a MLM that is trained/configured to process an input text content and to generate one or more questions as one or more outputs that can be answered from the input text content. For instance, the MLM may comprise a RNN, a LSTM model, a GAN, or the like. In one example, the MLM may comprise a ML language model, such as a LLM, e.g., a BERT model, a GPT model, a PaLM model, or other generative NLP models. In one example, the MLM may generate one or more questions in response to a tailored prompt e.g., using a prompt template, the prompt may be individualized by providing the text of a particular section and requesting the query be generated from the text contained in the section. The questions generated by second agent 220 may be associated with the respective source text file second in a set of question-section pairs 225.

Next, the questions generated via the second agent 220 may be passed to the machine learning (ML) language model 290, where for each question, the question may be passed to the ML language model 290 along with the respective text file section as additional context, e.g., supplemental prompt content (e.g., RAG content). The ML language model 290 may thus generate respective answers to the questions, which may be associated with the respective questions in question-answer (Q-A) pairs 235 (where the respective questions may remain associated with the respective source text file sections from which the questions are derived).

A third agent 230 may take the question-answer pairs 235 and may formulate groups of similar Q-A pairs, e.g., according to a similarity metric. For instance, the similarity metric may comprise a distance metric within a vector space/feature space associated with the Q-A pairs. For instance, each Q-A pair may be vectorized (e.g., into a feature vector) and then a distance between the vectors may be computed, such as a Euclidean distance, a Mahalanobis distance, etc. In one example, Q-A pairs that are within a threshold distance (which may be a configurable parameter set by a network operator, or which may be learned based upon feedback (such as a RLAF process)) may be grouped/placed into Q-A groups (or Q-A similarity groups). In another example, the third agent 230 may alternatively or additionally implement a clustering algorithm to determine which Q-A pairs to place in which Q-A groups based upon the similarity metrics (e.g., pair-wise similarity scores among respective pairs of Q-A pairs 235, e.g., a score for Q-A pair 1 to Q-A pair 2, a score for Q-A pair 1 to Q-A pair 3, etc.).

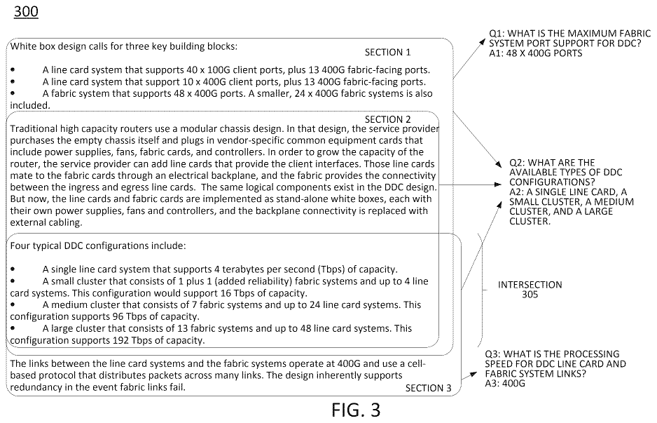

In one example, the third agent 230 may further determine a representative text sequence for each Q-A group based upon an intersection of the text file sections for each question of each Q-A pair within a given Q-A group. The result may be a set of text sequence to group associations 245. For instance, the text sequence may be a part of the text file that is contained within each/all of the text file sections associated with questions of the Q-A pairs within a given Q-A group. A representative example of the identification of a text sequence at the intersection of a plurality of text file sections is further illustrated in FIG. 3 and described in greater detail below. In one example, a text sequence that is associated with a Q-A group may be considered the core piece of information that contains an answer to a question, or the answer(s) to the questions in the group (e.g., where the questions are all “similar” according to the similarly metric of the question-answer pairs.).

As also noted above, in one example, the text file sections may continue to be refined to narrow down the text sequences containing core knowledge for particular questions/sets of similar questions by repeating some or all of the steps outlined above. For instance, this is illustrated by the arrow 280 in FIG. 2 indicating that the process 200 may return to the second agent 220 to refine the sections, to the machine learning language model 220 to generate answers to the questions, to the third agent to group Q-A pairs and to find intersecting text sequences, etc. (e.g., through as many iterations/loops as desired, such as according to a preselected number of iterations, a maximum number of iterations, and/or until a desired accuracy is achieved, etc.). In one example, smaller sections within each of the text file sections 215 may be created in a subsequent iteration/loop. In another example, new text file sections may be generated having different boundaries as the first set of text file sections 215 from the first iteration/loop.

In any case, the text sequence to group associations 245 may then be used in connection with provisioning of additional context from the text file for use in live question/query answering, e.g., by ML language model 290, or another ML language model that may similarly benefit from having more focused additional context data. In addition, it should be noted that the process 200 is just one example of a process/flow for developing a data set (e.g., text sequence to group associations) that may be used to enhance live question processing by a generative AI/ML language model-based system, and that other, further, and different processes and/or components of a same or similar nature may be used in various other examples. To illustrate, in one example, the ML language model of second agent 220 may comprise the core ML language model 290. For instance, the second agent 220 may comprise a module that comprises/maintains a tailored prompt for ML language model 290 to specifically cause the ML language model 290 to generate queries derived from input texts. In one example, the clustering of Q-A pairs into groups may similarly be performed via ML language model 290, e.g., where the third agent may comprise/maintain another tailored prompt to specifically cause the ML language model 290 to generate logical groupings (and similarly for the first agent 210, which may also initiate the task of generating text file sections to the ML language model 290 via a tailored prompt). Thus, these and other modifications are all contemplated within the scope of the present disclosure.

FIG. 3 illustrates an example of sectorizing/chunking a portion of a text file 300 into three overlapping chunks, or sections, e.g., sections 1-3. For instance, the portion of the text file 300 may comprise part of a document describing aspects of a white-box distributed disaggregated chassis (DDC) architecture for network routers. The sectorizing/chunking may be performed by first agent 210 of FIG. 2, for example. In addition, for each of sections 1-3, one or more questions may be automatically generated, such as via the second agent 220 of FIG. 2. The example questions (Q1-Q3) are shown on the right side of FIG. 3. The associated answers (A1-A3) (e.g., generated by ML language model 290 of FIG. 2) are also shown on the right side of FIG. 3. Notably, only section 1 generates the first question (Q1). Thus, the answer A1 is answerable only from section 1. Similarly, only section 3 generates the third question (Q3). Thus, the answer A3 is only answerable from section 3. However, the second question (Q2) is generated from each/all of sections 1-3. Thus, second question (Q2) is answerable from the intersection 305 of all of the source sections 1-3.

It should be noted that the example of FIG. 3 has been simplified. For example, the second question Q2 may be representative of three similar but slightly different questions which may be generated from sections 1-3, respectively. Likewise the answer A2 may be representative of three similar but slightly different answers (e.g., which may be generated by ML language model 290 of FIG. 2 from the slightly different questions sourced from the respective sections 1-3). In other words, three similar Q-A pairs may have been previously grouped and are symbolized in FIG. 2 by a representative Q-A pair of Q2-A2. Notably, when processing a new, live question/query via a ML language model system the input question/query may be matched to the question Q2 (e.g., via a similarly metric). In response, the system may then retrieve the text of intersection 305 for additional context. In this regard, additional aspects of live query/question processing are described in greater detail below in connection with the example method 400 of FIG. 4.

FIG. 4 illustrates a flowchart of an example method 400 for processing a query via a machine learning language model using a text sequence identified within at least a portion of text file associated with a group that is matched to the query and that includes one or more questions of one or more question-answer pairs grouped based on a similarity metric. In one example, steps, functions, and/or operations of the method 400 may be performed by a device as illustrated in FIG. 1, e.g., one or more of the servers 135, or the like, such as a language model agent. Alternatively, or in addition, the steps, functions and/or operations of the method 400 may be performed by a processing system collectively comprising a plurality of devices as illustrated in FIG. 1 such as one or more of the servers 135, DB(s) 136, endpoint devices 111-113 and/or 121-123 (e.g., user equipment (UE), or the like), and so forth. In one example, the steps, functions, or operations of method 400 may be performed by a computing device or system 500, and/or a processing system 502 as described in connection with FIG. 5 below. For instance, the computing device 500 may represent at least a portion of a platform, a server, a system, and so forth, in accordance with the present disclosure. For illustrative purposes, the method 400 is described in greater detail below in connection with an example performed by a processing system. The method 400 begins in step 405 and proceeds to step 410.

At step 410, the processing system sectionalizes at least a portion of a text file into a plurality of sections, where each section of the plurality of sections overlaps with at least one other section of the plurality of sections. For instance, the operations of step 410 may comprise the same or similar operations as described above with respect to the first agent 210 of FIG. 2. In one example, step 410 may be performed via a first AI agent implemented by the processing system (such as first agent 210 of FIG. 2 or the like) that may be configured to sectionalize text file contents into sections based upon one or more of: line break markers, paragraph break markers, section break markers, indentation markers, punctuation markers, grammatical markers, and so forth. In one example, the first AI agent may comprise a first MLM. In one example, step 410 may be performed via a ML language model implemented by the processing system (e.g., a core ML language model that may be used for question/query processing as described herein). For instance, step 410 may include using a tailored prompt instructing the ML language model to generate text file sections from an input text. In other words, in one example, the sectionalization that is performed via the ML language model may be in response to a prompt that requests sectionalization of at least a portion of the text file.

At step 415, the processing system generates, for each section of the plurality of sections, a question from a respective text of the section, where the question is associated with the section in a question-section pair, and where the generating results in a plurality of question-section pairs associated with a plurality of questions for the plurality of sections. For instance, the operations of step 415 may comprise the same or similar operations as described above with respect to the second agent 220 of FIG. 2. In one example, step 415 may be performed via a second AI agent implemented by the processing system (such as second agent 220 of FIG. 2 or the like) that may be configured to generate questions from text inputs. For instance, in one example, the second AI agent may comprise a second MLM, e.g., a RNN, a LSTM, a GAN etc. In one particular example, the second MLM may comprise a second ML language model, e.g., that is different from a core ML language model implemented by the processing system for question/query processing as described herein. For instance, such a second ML language model may generate one or more questions for each section in response to a prompt that requests generating of the question for each section, e.g., using a prompt template, the prompt may be individualized by providing the text of a particular section and requesting one or more queries to be generated from the text contained in the section. However, in another example, the generating of the question for each section of the plurality of sections may be performed via the ML language model (e.g., the core ML language model) in response to a prompt that requests generating of the question for each section, e.g., using a prompt template such as described above.

At step 420, the processing system applies each question of the plurality of questions to a machine learning (ML) language model that is configured to generate a plurality of answers to the plurality of questions, where for each question, the applying includes appending the respective text of the section that is associated with the question as supplemental prompt content, e.g., RAG content. For instance, the ML language model of step 420 may comprise the core ML language model described above that may be used for live question/query processing for users/clients as described herein. As noted above, the ML language model may be a BERT model, a GPT model, a LaMDA model, a PaLM model, or the like.

At step 425, the processing system associates each question with a respective answer of the plurality of answers obtained via the applying to generate a question-answer pair of a plurality of question-answer pairs (such as question-answer pairs 235 of FIG. 2).

At step 430, the processing system groups the plurality of question-answer pairs into a plurality of groups based upon a similarity metric. In one example, step 430 may be performed by the processing system via a third AI agent that is implemented by the processing system, such as third agent 230 of FIG. 2 or the like. For instance, the third AI agent may comprise a third MLM. In one example, such an MLM may comprise a clustering model. To further illustrate, as noted above, the similarity metric may comprise a distance metric within a vector space/feature space associated with the question-answer (Q-A) pairs. For instance, each question-answer pair may be vectorized (e.g., into a feature vector) and then pair-wise distances between the vectors may be computed, such as a Euclidean distance, a Mahalanobis distance, etc. In one example, Q-A pairs that are within a threshold distance may be grouped/placed into Q-A groups. In another example, step 430 may include applying a clustering model or clustering algorithm to determine which Q-A pairs to place in which Q-A groups based upon the similarity metrics.

At step 435, the processing system identifies, for at least a first group of the plurality of groups, a text sequence that is within an intersection of the sections in the question-section pairs associated with the respective questions in the question-answer pairs within the first group, where the text sequence is associated with the group as a result of the identifying. For instance, the intersection may comprise the text that is contained in each/all of the sections, such as illustrated in the example of FIG. 3.

At optional step 440, the processing system may retrain the ML language model via a reinforcement learning through an artificial intelligence (RLAF) feedback process using examples comprising, for each example, a question of one of the groups with a respective text sequences of the one of the groups as a correct result for obtaining the additional context.

At step 445, the processing system obtains a query for the ML language model. For instance, the query, e.g., a subsequent question, may be obtained from a user and/or client system in a deployment phase of the ML language model, e.g., “in production” or “live.” The query may relate to the subject matter of the at least the portion of the text file that is sectionalized at step 410.

At step 450, the processing system matches the query to the first group. In one example, the matching of the query to the first group may be via a context locator agent associated with the ML language model. For instance, the context locator agent may comprise a component or layer(s) of the ML language model and/or another AI agent (e.g., an LLM agent or tool). Alternatively, the context locator agent may comprise a retrieval augmented generation (RAG) agent that is tasked with obtaining additional relevant content/context to append to a prompt/input query. In one example, step 450 may include retrieving the associated text sequence.

At step 455, the processing system processes the query via the ML language model to obtain a first answer to the query as an output, where the query is processed via the ML model using with the text sequence as additional context based upon the matching of step 450. In one example, the matching of the query to the first group and the processing of the query via the ML language model are via the ML language model that is retrained via the RLAF process at optional step 440. In another example, the processing of step 445 may include appending the text sequence as supplemental prompt content, e.g., RAG content.

At optional step 460, the processing system may present the first answer, e.g., the output. In one example, the output may be presented via a client GUI associated with the ML language model. For instance, the output of a first answer may be presented in a text format, in an audio format, e.g., via text-to-speech, and so forth. Following step 455 or optional step 460, the method 400 ends in step 495.

It should be noted that method 400 may be expanded to include additional steps, or may be modified to replace steps with different steps, to combine steps, to omit steps, to perform steps in a different order, and so forth. For instance, in one example, the processing system may repeat one or more steps of the method 400, such as steps 410-435 for additional iterations and refinement of the sections and text sequences, steps or 445-455 for new queries/questions, steps 410-435 for additional text files and/or portions of the same text file not processed in the first iteration of steps 410-425, and so forth. In one example, the method 400 may include obtaining feedback and retraining one or more AI agents, e.g., additional MLMs besides the core ML language model, etc. Alternatively, or in addition, the method 400 may include other pre-or post-processing operations, such as ETL operations, data cleansing, sanitizing, averaging, etc.

In one example, step 410 may comprise generating random sections, e.g., of random sizes/lengths and/or random start points and/or end points within the text file. In one example, this may be implemented in a single pass or in multiple iterations/loops of steps 410-435. In one example, step 410 may be preceded by pre-processing a non-text data file into a text-based format, e.g., converting a table, a network topology, etc. into a natural language (NL) text file, e.g., a NL document. In one example, steps 450-455 or steps 445-455 may be with respect to a different ML language model. For instance, there may be multiple similar and/or parallel models available for the same or similar NL query processing tasks. Thus, development of a data set of text sequence to group associations may be consolidated to one training ML language model rather than repeating the same process independently for each of the ML language models. In one example, the method 400 may be expanded or modified to include steps, functions, and/or operations, or other features described above in connection with the example(s) of FIGS. 1-3, or as described elsewhere herein. Thus, these and other modifications are all contemplated within the scope of the present disclosure.

In addition, although not specifically specified, one or more steps, functions, or operations of the method 400 may include a storing, displaying, and/or outputting step as required for a particular application. In other words, any data, records, fields, and/or intermediate results discussed in the method 400 can be stored, displayed and/or outputted either on the device executing the method 400, or to another device, as required for a particular application. Furthermore, steps, blocks, functions, or operations in FIG. 4 that recite a determining operation or involve a decision do not necessarily require that both branches of the determining operation be practiced. In other words, one of the branches of the determining operation can be deemed as an optional step. In addition, one or more steps, blocks, functions, or operations of the above described method 400 may comprise optional steps, or can be combined, separated, and/or performed in a different order from that described above, without departing from the examples of the present disclosure.

FIG. 5 depicts a high-level block diagram of a computing device or processing system specifically programmed to perform the functions described herein. For example, any one or more components or devices illustrated in FIG. 1 or described in connection with the example(s) of FIG. 2-4 may be implemented as the processing system 500. As depicted in FIG. 5, the processing system 500 comprises one or more hardware processor elements 502 (e.g., a microprocessor, a central processing unit (CPU) and the like), a memory 504, (e.g., random access memory (RAM), read only memory (ROM), a disk drive, an optical drive, a magnetic drive, and/or a Universal Serial Bus (USB) drive), a module 505 for processing a query via a machine learning language model using a text sequence identified within at least a portion of text file associated with a group that is matched to the query and that includes one or more questions of one or more question-answer pairs grouped based on a similarity metric, and various input/output devices 506, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in FIG. 5, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of FIG. 5 is intended to represent each of those multiple computing devices. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 502 can also be configured or programmed to cause other devices to perform one or more operations as discussed above. In other words, the hardware processor 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 505 for processing a query via a machine learning language model using a text sequence identified within at least a portion of text file associated with a group that is matched to the query and that includes one or more questions of one or more question-answer pairs grouped based on a similarity metric (e.g., a software program comprising computer-executable instructions) can be loaded into memory 504 and executed by hardware processor element 502 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for processing a query via a machine learning language model using a text sequence identified within at least a portion of text file associated with a group that is matched to the query and that includes of one or more questions of one or more question-answer pairs grouped based on a similarity metric (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
sectionalizing, by a processing system including at least one processor, at least a portion of a text file into a plurality of sections, wherein each section of the plurality of sections overlaps with at least one other section of the plurality of sections;
generating, by the processing system for each section of the plurality of sections, a question from a respective text of the section, wherein the question is associated with the section in a question-section pair, wherein the generating results in a plurality of question-section pairs associated with a plurality of questions for the plurality of sections;
applying, by the processing system, each question of the plurality of questions to a machine learning language model that is configured to generate a plurality of answers to the plurality of questions, wherein for each question, the applying includes appending the respective text of the section that is associated with the question as supplemental prompt content;
associating, by the processing system, each question with a respective answer of the plurality of answers obtained via the applying to generate a question-answer pair of a plurality of question-answer pairs;
grouping, by the processing system, the plurality of question-answer pairs into a plurality of groups based upon a similarity metric;
identifying, by the processing system for at least a first group of the plurality of groups, a text sequence that is within an intersection of the sections in the question-section pairs associated with the respective questions in the question-answer pairs within the first group, wherein the text sequence is associated with the first group as a result of the identifying;
obtaining, by the processing system, a query for the machine learning language model;
matching, by the processing system, the query to the first group; and
processing, by the processing system, the query via the machine learning language model to obtain a first answer to the query as an output, wherein the query is processed via the machine learning model using with the text sequence as additional context based upon the matching.

2. The method of claim 1, wherein the sectionalizing is via a first artificial intelligence agent that is implemented by the processing system.

3. The method of claim 2, wherein the first artificial intelligent agent is configured to sectionalize text file contents of the text file into the plurality of sections based upon one or more of:
line break markers,
paragraph break markers;
section break markers;
indentation markers;
punctuation markers; or
grammatical markers.

4. The method of claim 2, wherein the first artificial intelligence agent comprises a first machine learning model.

5. The method of claim 1, wherein the sectionalizing is performed via the machine learning language model in response to a prompt that requests sectionalization of at least a portion of the text file.

6. The method of claim 1, wherein the machine learning language model is implemented by the processing system.

7. The method of claim 1, wherein the machine learning language model comprises:
a bidirectional encoder representations from transformers model;
a generative pre-training model;
a language model for dialogue applications model; or
a pathways language model.

8. The method of claim 1, wherein the generating of the question for each section of the plurality of sections is via a second artificial intelligence agent that is implemented by the processing system.

9. The method of claim 8, wherein the second artificial intelligence agent comprises a second machine learning model.

10. The method of claim 9, wherein the second machine learning model comprises a second machine learning language model.

11. The method of claim 1, wherein the generating of the question for each section of the plurality of sections is performed via the machine learning language model in response to a prompt that requests generating of the question for each section.

12. The method of claim 1, wherein the grouping of the plurality of question-answer pairs into the plurality of groups based upon the similarity metric is via a third artificial intelligence agent that is implemented by the processing system.

13. The method of claim 12, wherein the third artificial intelligence agent comprises a third machine learning model.

14. The method of claim 13, wherein the third machine learning model comprises a clustering model.

15. The method of claim 1, wherein the text file comprises:
a text document; or
computer programming code.

16. The method of claim 1, wherein the matching of the query to the first group is via a context locator agent associated with the machine learning language model.

17. The method of claim 1, further comprising:
retraining the machine learning language model via a reinforcement learning through artificial intelligence feedback process using examples comprising, for each example a question of one of the plurality of groups with a respective text sequences of the one of the plurality of groups as a correct result for obtaining the additional context.

18. The method of claim 17, wherein the matching of the query to the first group and the processing of the query via the machine learning language model is via the machine learning language model that is retrained via the reinforcement learning through artificial intelligence feedback process.

19. A non-transitory computer-readable medium storing instructions which, when executed by a processing system including at least one processor, cause the processing system to perform operations, the operations comprising:
sectionalizing at least a portion of a text file into a plurality of sections, wherein each section of the plurality of sections overlaps with at least one other section of the plurality of sections;
generating, for each section of the plurality of sections, a question from a respective text of the section, wherein the question is associated with the section in a question-section pair, wherein the generating results in a plurality of question-section pairs associated with a plurality of questions for the plurality of sections;
applying each question of the plurality of questions to a machine learning language model that is configured to generate a plurality of answers to the plurality of questions, wherein for each question, the applying includes appending the respective text of the section that is associated with the question as supplemental prompt content;
associating each question with a respective answer of the plurality of answers obtained via the applying to generate a question-answer pair of a plurality of question-answer pairs;
grouping the plurality of question-answer pairs into a plurality of groups based upon a similarity metric;
identifying, for at least a first group of the plurality of groups, a text sequence that is within an intersection of the sections in the question-section pairs associated with the respective questions in the question-answer pairs within the first group, wherein the text sequence is associated with the first group as a result of the identifying;
obtaining a query for the machine learning language model;
matching the query to the first group; and
processing the query via the machine learning language model to obtain a first answer to the query as an output, wherein the query is processed via the machine learning model using with the text sequence as additional context based upon the matching.

20. An apparatus comprising:
a processing system including at least one processor; and
a computer-readable medium storing instructions which, when executed by the processing system, cause the processing system to perform operations, the operations comprising:
sectionalizing at least a portion of a text file into a plurality of sections, wherein each section of the plurality of sections overlaps with at least one other section of the plurality of sections;
generating, for each section of the plurality of sections, a question from a respective text of the section, wherein the question is associated with the section in a question-section pair, wherein the generating results in a plurality of question-section pairs associated with a plurality of questions for the plurality of sections;
applying each question of the plurality of questions to a machine learning language model that is configured to generate a plurality of answers to the plurality of questions, wherein for each question, the applying includes appending the respective text of the section that is associated with the question as supplemental prompt content;
associating each question with a respective answer of the plurality of answers obtained via the applying to generate a question-answer pair of a plurality of question-answer pairs;
grouping the plurality of question-answer pairs into a plurality of groups based upon a similarity metric;
identifying, for at least a first group of the plurality of groups, a text sequence that is within an intersection of the sections in the question-section pairs associated with the respective questions in the question-answer pairs within the first group, wherein the text sequence is associated with the first group as a result of the identifying;
obtaining a query for the machine learning language model;
matching the query to the first group; and
processing the query via the machine learning language model to obtain a first answer to the query as an output, wherein the query is processed via the machine learning model using with the text sequence as additional context based upon the matching.
